(19) United States
(12) Patent Application Publication
(10) Pub. No.: US 2011/0090077 A1
(43) Pub. Date: Apr. 21, 2011

(54) WINDOW HANDLE OR DOOR HANDLE WITH POSITION MONITORING FOR MONITORING ROOM CLIMATE AND VENTILATION BEHAVIOR

(76) Inventors: Georg Meyer, Solingen (DE); Kurt Spitzer, Solingen (DE); Markus Disch, Solingen (DE)

(21) Appl. No.: 12/741,610

(22) PCT Filed: Nov. 22, 2008
(86) PCT No.: PCT/DE2008/001944

§ 371 Date: May 19, 2010

(30) Foreign Application Priority Data
Nov. 29, 2007 (DE) 20 2007 016 687.7

(51) Int. Cl. G08B 19/00; E05F 11/02; E05F 11/54

(52) U.S. Cl. 340/521; 16/412

(57) ABSTRACT

The invention relates to a device for monitoring room climate and ventilation behavior in and of inside rooms, having a readable memory unit, a control unit, and a signal generator that are integrated into a window or door handle, wherein the memory unit and/or the control unit is connected to at least one of the following sensors: a sensor that registers the position of the window or door handle (open, closed, or tilted), which may then be stored with the associated time data, or a sensor that measures the room temperature, or a sensor that measures the relative or absolute humidity of the room air such that, upon the room temperature falling below a preprogrammable value and/or upon the room air humidity exceeding a preprogrammable value, the signal generator is activated.

The invention described below relates to a monitoring apparatus for monitoring the climate and the ventilation behavior in and of interior spaces.

Insufficient ventilation is unhealthy. In “lively” interior spaces that are not ventilated regularly or are not ventilated at all by the user of the room (owner, tenant or other holders of rights of use), the air humidity increases demonstrably. Besides breath and other body emissions, the increase of air humidity in living rooms is primarily increased in a disadvantageous manner by cooking, showering or bathing and air drying of washed laundry. Permanent above-average air humidity stimulates mold formation, for example on walls and underneath wallpaper. By spores released into the air, on the one hand, the health of the user of the space is affected and, on the other hand, by mold growth and/or moisture penetration into the walls, furniture or even the structure of the building can be significantly damaged.

In contrast, excessive ventilation of heated interior spaces is inefficient with respect to wasting of natural resources and the associated increasing energy cost and the global environment and climate issues, and must be avoided, if possible.

Up to now, the following monitoring apparatuses for permitting an optimal ventilation behavior were introduced:

In DE 20 2004 003 541 U1, a measuring apparatus for determining the mold parameters and complying with the mold parameters is disclosed. The measuring apparatus described therein can be attached directly to a building part and is supplied with power independently of the mains. For determining surface temperature, air temperature, the air humidity, the apparatus is equipped with respective sensors by means of which the expected mold growth can be calculated. When the values fall below certain limit values, an acoustic or optical alarm signal is activated to which the user of the space can react by ventilating the room.

In DE 10 2006 032 858 B4, a method of and apparatus for controlled ventilation of a room is disclosed. The apparatus comprises the following:
a temperature sensor for measuring a temperature the room,
a temperature sensor for measuring temperature outside the room,
a humidity sensor for measuring relative air humidity inside the room,
a humidity sensor for measuring relative air humidity outside the room,
a ventilator, and
a controller.

Both apparatuses are designed in such a manner that the user thereof is able to use them in an appropriate manner and can subsequently comply with the proposed ventilation behavior. A subsequent check (for example by the landlord) of ventilation behavior (for example of the tenant) that lies in the past is not possible with the above-mentioned apparatuses of the prior art. If improper ventilation has damaged the building due to mold formation and/or moisture penetration into the walls, at present a landlord has almost no possibility to ascribe the faulty ventilation behavior to the tenant or to prove that the damage is caused by his insufficient ventilation. The enforcement of damage claims against the tenant is therefore almost impossible in such cases because it is difficult to provide evidence so that up to now any damage that has occurred has to be borne by the landlord or the owner of the building.

Therefore, it is the object of the present invention to provide an apparatus that, on the one hand, signals to the user of the space (owner, tenant or other holders of rights of use) of living spaces, office rooms and other heatable interior spaces when ventilation is required to prevent mold formation and, on the other hand, provides a possibility (for example to the landlord) for a subsequent check of the ventilation behavior (for example of the tenant).

The object is attained by a monitoring apparatus according to claim 1 that comprises a readable storage unit, a controller, and an alarm that are integrated into a window or door handle, the storage unit and/or the controller being connected to at least one of the following sensors:
a) a sensor that records the position of the window or door handle (open, closed or ajar) that can then be stored with the associated time data,
b) a sensor that measures the room temperature,
c) a sensor that measures the relative or absolute humidity of the room air,
   such that, upon the room temperature falling below a preprogrammable value and/or upon the room air humidity exceeding a preprogrammable value, the alarm is activated. On the one hand, with the proposed monitoring apparatus, optimal ventilation behavior is determined by means of the outputs of the room temperature sensor and the room air humidity sensor so that the user of the space is requested by the alarm to ventilate. On the other hand, a readable or downloadable storage unit holds the measured data, in particular the room temperature, the air humidity, but also the window or door positions, so it can be retrieved. This data can be read by the user of the space himself or by a third party (for example the landlord) after freely selectable time intervals that can be several years, if needed, and can be displayed graphically on a computer by means of software. Thus, poor ventilation can be detected or corrected early. In case of continuous improper ventilation behavior (for example of the tenant) objectively detected by the recorded data, it is possible to prove fault and therefore it is possible to make a damage claim against the responsible party.

In addition to elevated room air humidity and the suboptimal room temperature, an excessive CO₂ concentration and mold-spore density in the air contribute to the missing comfortable feeling of the user of the space and to increasing mold formation. Accordingly, in addition to what has been said before, a sensor for measuring the mold spores density and/or the CO₂ concentration is connected with the storage unit and alarm unit.

According to a preferred embodiment it is further provided that, in addition, a sensor for measuring the outside temperature and/or the outside air humidity is available. These sensors can be set at any distance from the window or door handle having the monitoring apparatus and can be connected wirelessly with the controller. Alternatively, the outside sensors can also be integrated in the window or door handle itself, wherein it is provided that the sensors are mounted by means of a small bore hole through the window or door frame on the outer side of the same. By these measures, the ventilation behavior can be optimally adapted to the external climatic conditions that arise in particular from the different times of the day and the different seasons of the year. Thus, for example, the user of the space is not immediately requested to ventilate when the outside air humidity is higher than the air humidity in the interior space, even if the same has exceeded a certain limit value.

Preferably, the alarm is activated if one of the following states is reached:
a) a preselectable temperature differential between the outside and inside temperature is reached or exceeded,
b) a selectable inside temperature is reached or the temperature falls below or exceeds it,
c) a preselectable time period within which the window or door was open is reached or exceeded,
d) a preselectable CO₂ concentration is exceeded, and/or
e) a preselectable air humidity difference between the outside and inside air humidity is exceeded provided that a preprogrammable inside air humidity is exceeded as well.

According to a preferred embodiment, the monitoring apparatus is provided with an alarm that outputs an optical, acoustic, or mechanical signal. For outputting an optical signal, for example, light bulbs or an LED display can be provided. For acoustic signals, high-frequency signals or ring tones are well suited. Mechanical signals can be transferred, for example, through vibration in an analog manner as with mobile phones.

In order that, in particular, the outside temperature sensors and the alarms can be positioned at different places, it is preferred to transmit data between the outside temperature sensors and the alarm wirelessly, preferably via radio or infrared. Also, the monitoring apparatus can be configured as a central monitoring apparatus for a plurality of rooms. To this end for example in a household or in an office, a monitoring apparatus is provided in each heatable interior space. These monitors are wirelessly connected with a central receiver with its integrated alarm in such a manner that the climate monitoring can be carried out separately for each room and from any central location. Moreover, according to a particular embodiment the alarm can output different signals in such a manner that each signal is allocated to an inside temperature sensor of a respective interior space. By means of this particular embodiment, the ventilation process can be monitored in different rooms of a household at the same time. By means of different signals allocated to the different interior spaces, the user of the space can stop the potentially excessive ventilation quickly and unerringly.

In addition, the monitoring apparatus according to the invention serves, in particular, to give a landlord the possibility to check the ventilation behavior of his tenant. The readable storage unit necessary for this purpose preferably has an interface, preferably a USB port. However, other interfaces such as, for example, Bluetooth or infrared are also conceivable.

Moreover, the limit values can be changed by a computer connected with the monitoring apparatus through the interface in such a manner that the limit values can be adapted to the given basic conditions such as, for example, the construction of the building complex or the season of the year. It has to be possible to clear the memory after reading the data.

According to a further embodiment, the monitoring apparatus has an optical alarm with an LED display that preferably can emit light of different colors. This LED display shows the user of the space if and how, if necessary, his ventilation behavior is to be improved. For this purpose, preferably, different flashing signals are provided that differ in color, intensity, and flashing duration.

For accurately recording the window or door handle position (open, closed or ajar) one or more magnets or one or more Hall sensors are arrayed in a substantially annular manner around the window handle to record and retrievably store each handle position and thus the position of the window and, in addition, all changes by means of magnetic pulses or by one or more Hall sensors.

For power supply to all electronic components, a battery, an wet cell or solar cells are provided. To ensure that data do not get lost during changing of a battery or wet cell, a nonvolatile memory is preferably used.

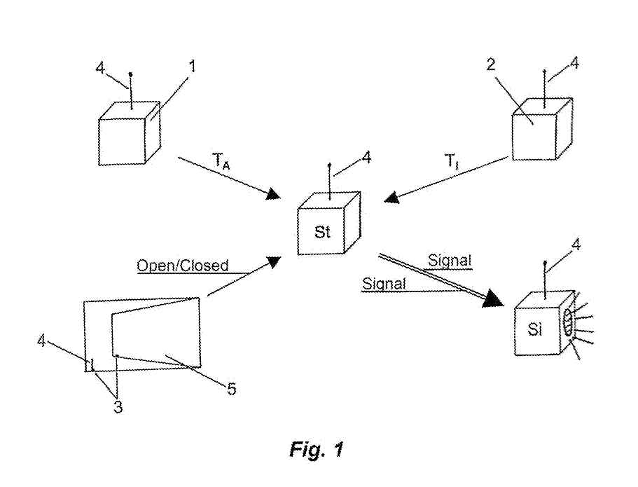

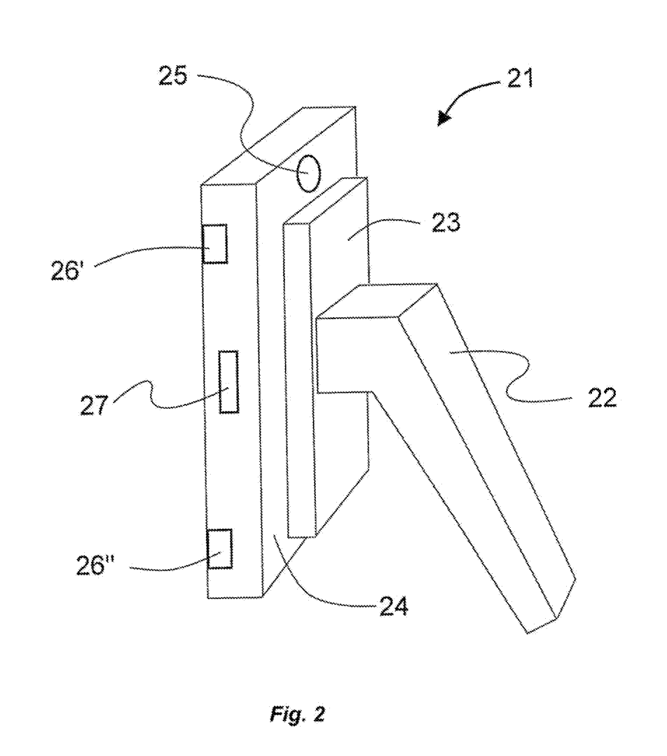

Concrete embodiments of the present invention are shown hereinafter by means of FIGS. 1 and 2.

The monitoring apparatus shown in FIG. 1 comprises two temperature sensors 1 and 2, one sensor 3 at the window 5, one controller St, and one alarm Si. Moreover, all components have an antenna 4 by means of which data are transferred. The temperature sensor 1 measures the outside temperature T_{A} and temperature sensor 2 measures the inside temperature T_{I}. Both measured values are transferred wirelessly to the controller St. On the lower side of window 5, the sensor 3 records if the window is open or closed. This data is transferred to the controller St as well. Depending on the selected program, the controller St that is wirelessly connected with the alarm Si, controls if the alarm outputs a signal or not. For example, a signal is outputted when the window is open and the temperature differential T_{A}-T_{I} has exceeded a selectable critical value.

In FIG. 2, a monitoring unit integrated into a window handle assembly 21 is shown. The handle 22 is rotatably mounted on the so-called rosette 23 inside of which the (unillustrated) Hall sensors are provided by means of which the window position can be recorded. The rosette 23 is fixed on the monitoring apparatus 24, at whose upper end the alarm 25 is provided, in the illustrated embodiment an LED display. At the side of the monitoring apparatus 24, holes 26′, 26″ are provided through which air flows into the monitoring apparatus 24. Thus, the climatic variables can be measured internally. For reading the measured and recorded data, a USB interface 27 is provided on the side of the monitoring apparatus 27.

1. An apparatus for monitoring the room climate and the ventilation behavior in and of interior spaces, comprising a readable storage unit, a controller, and an alarm that are integrated into a window or door handle, the storage unit or the controller being connected to at least one of the following sensors:
a) a sensor that records the position of the window or door handle (open, closed or ajar) that can then be stored with the associated time data,
b) a sensor that measures the room temperature,
c) a sensor that measures the relative or absolute air humidity of the room,
such that, when the room temperature falls below a preprogrammable value or when the room air humidity exceeds a preprogrammable value, the alarm is activated.

2. The monitoring apparatus according to claim 1, wherein a sensor for measuring mold spores density or CO₂ concentration is connected to the storage unit and alarm.

3. The monitoring apparatus according to claim 1 wherein, in addition, a sensor for measuring the outside temperature or outside air humidity is provided.

4. The monitoring apparatus according to claim 3, wherein the alarm is activated if one of the following states is reached:
a) a preselectable temperature differential between the outside and inside temperature is reached or exceeded,
b) a selectable inside temperature is reached or the temperature falls below or exceeds it,
c) a preselectable time period within which the window or door was open is reached or exceeded,
d) a preselectable CO₂ concentration is exceeded, or
e) a preselectable air humidity difference between the outside and inside air humidity is exceeded provided that a preprogrammable inside air humidity is exceeded as well.

5. The monitoring apparatus according to claim 1 wherein the alarm outputs an optical, acoustic, or mechanical signal.

6. The monitoring apparatus according to claim 1 further comprising
means for a wireless data transfer via radio or infrared signal between the sensors, the alarm and the controller.

7. The monitoring apparatus according to claim 1, wherein the apparatus is configured as a central monitoring apparatus for a plurality of rooms.

8. The monitoring apparatus according to claim 1, further comprising
an interface connected to the storage unit for reading the measured and recorded data.

9. The monitoring apparatus according to claim 1 wherein the alarm has at least one LED display with different light colors.

10. The monitoring apparatus according to claim 1 wherein the window handle or door handle position (open, closed or ajar) can be recorded by means of one or more magnets arrayed in a substantially annular manner and that, depending on the position of the magnets, record the handle position and thus the position of the window, or by means of one or more Hall sensors.

11. The monitoring apparatus according to claim 1 wherein for the power supply to all electronic components, a battery, a wet cell, or a solar-cell power supply is provided, the storage unit being nonvolatile so that data do not get lost during changing of a battery or wet cell or any other power interruption.

12. (canceled)

13. In combination:
a handle assembly of a door or window;
a sensor in the assembly for generating outputs indicating indoor and outdoor temperature;
a sensor in the assembly for generating an output indicating whether the door or window is open or closed;
a controller for evaluating the outputs; and
an alarm connected to the controller for generating an alarm signal when the controller determines a dangerous condition based on the outputs.

14. The combination defined in claim 13, further comprising
a wireless interface for transmitting the outputs from the sensors to the controller.
